(19) United States
(12) Patent Application Publication
(10) Pub. No.: US 2025/0211501 A1
(43) Pub. Date: Jun. 26, 2025

(54) METHOD FOR PACKET-BASED NETWORK MONITORING IN AN O-RAN SYSTEM

(71) Applicant: Robert Bosch GmbH, Stuttgart (DE)

(72) Inventors: David Osamu Ginthoer, Stuttgart (DE); Davit Harutyunyan, Boeblingen (DE); Henrik Klessig, Renningen (DE); Rene Guillaume, Boeblingen (DE)

(21) Appl. No.: 18/983,100

(22) Filed: Dec. 16, 2024

(30) Foreign Application Priority Data
Dec. 21, 2023 (DE) 10 2023 213 194.3

(51) Int. Cl. H04L 43/024; H04L 41/0816; H04L 43/04

(52) U.S. Cl. CPC H04L 43/024; H04L 41/0816; H04L 43/04

(57) ABSTRACT

A method for packet-based network monitoring in an O-RAN system to initiate a measure for adapting network monitoring. The method includes: capturing data packets at an interface of the O-RAN system using an O-RAN service model; extracting information relating to each data packet on the basis of a selection criterion for network monitoring, wherein the selection criterion is specific to a particular network monitoring task; aggregating the extracted information relating to each data packet to analyze the data contained in the information; analyzing the data from the aggregated information based on a predetermined analysis model, wherein the analysis model includes an algorithm for evaluating the data; initiating a measure to adapt network monitoring based on the result of the analysis.

### FIELD

The present invention relates to a method for packet-based network monitoring in an O-RAN system. The present invention further relates to a network function, a computer program, and a computer-readable storage medium for this purpose.

### BACKGROUND INFORMATION

An underlying network infrastructure with reliable and highly deterministic transmission or forwarding capabilities is an important basis for applications having safety-critical and cost-sensitive impacts, e.g., in the industrial or automotive sectors. Communication technologies based on the 5G or 6G standards increasingly include mechanisms such as methods for redundant transmission and highly configurable, synchronized traffic control.

With the introduction of Open RAN (open radio access network) systems, or O-RAN systems, additional functions can be used in a 5G/6G communications network to control data traffic within the communications network. An Open RAN (open radio access network) system is a telecommunications system that replaces the traditional architecture of mobile networks with a disaggregated and open structure. This system may comprise various components, interfaces or functions, such as a radio unit (RU), a distributed unit (DU), a centralized unit (CU), and various interfaces between these components.

Due to limited access to information at a lower level of a protocol stack, today's network monitoring systems only provide few performance measurements, e.g., regarding data packet rate, data packet loss or cyclic redundancy checks. Endpoints in a communications network, such as user equipment on which an application can be operated, can feature appropriate error counters for the aforementioned measurement purpose. An example of this is an industrial application that cyclically receives input data. In cases where too many consecutive data packet losses occur during data transmission in a network, said application can be controlled to enter a safe state. However, subsequent troubleshooting based on an analysis of performance measurements can be difficult and costs valuable time.

### SUMMARY

The present invention includes a method, a network function, a computer program, and a computer-readable storage medium.

Features of and details relating to the present invention can be found in the disclosure herein. Features and details which are described in connection with the method according to the present invention of course also apply in connection with the network function according to the present invention, the computer program according to the present invention, and the computer-readable storage medium according to the present invention, and respectively vice versa, so that, with respect to the disclosure, mutual reference is or can be made to the individual aspects of the present invention at all times.

The present invention relates in particular to a method for packet-based network monitoring in an O-RAN system in order to initiate a measure for adapting network monitoring. According to an example embodiment of the present invention, the method comprises the following steps:
capturing data packets at an interface of the O-RAN system using an O-RAN service model;
extracting information relating to each data packet on the basis of a selection criterion for network monitoring, wherein the selection criterion is specific to a particular network monitoring task;
aggregating the extracted information relating to each data packet in order to analyze the data contained in the information;
analyzing the data from the aggregated information on the basis of a predetermined analysis model, wherein the analysis model comprises an algorithm for evaluating the data;
initiating a measure to adapt network monitoring on the basis of the result of the analysis.

The method according to the present invention enables significantly more powerful and detailed network monitoring to be provided on the basis of an advantageous application of O-RAN technology. This also has the advantage that detailed information about individual packets can not only be available at the endpoints, but can also be tracked by the network infrastructure itself. Furthermore, the method according to the present invention allows the performance of forwarding packets through the network to be better analyzed. A network can be a communications network such as a communications network according to a 3GPP standard such as 4G, 5G or 6G.

Advantageously, the use of costly special measuring devices to collect data or, for example, to debug errors can be moreover avoided. This also has the advantage that the method according to the present invention performs network monitoring on the basis of low-layer information in the network stack, which would normally not be available for software-based monitoring components in communications networks.

The present invention moreover enables significantly better tracking of application errors during post-processing of the monitoring data from the data packets. This advantageously reduces downtimes and improves the overall efficiency of the application.

Furthermore, within the scope of the present invention, it may be advantageous for the method to comprise the following further step:
selecting a particular data packet from the captured data packets depending on the selection criterion for network monitoring.

This allows network monitoring according to the present invention to filter out irrelevant data packets in an effective and efficient manner and thus advantageously to extract only the information that is relevant to the particular network monitoring task depending on the selection criterion in order to be more computationally efficient. Furthermore, this has the advantage that for a specific monitoring task only the data relating to the data packets of a specific application can be selected for further analysis and/or processing.

Advantageously, within the scope of the present invention, capturing may comprise the following further step:
capturing data packets on the basis of at least one piece of network layer information, the network layer information being specific to any protocol layer of a network protocol stack.

This allows network monitoring and/or performance degradation to be advantageously detected at a lower layer of the communications stack or protocol stack. This has the advantage that any processing delays of data packets at each layer can be effectively visualized in order to identify technical problems regarding the transmission of data packets. The ability to, for example, track data packets of a specific application across the entire protocol stack and to determine whether retransmissions, packet segmentation, or out-of-order transmissions, etc. may have occurred for that application makes it possible to identify network problems for specific, selected end devices.

A network stack, also referred to as a protocol stack or communications protocol stack, is a software architecture or collection of network protocols organized into layers to enable communication between different computers or devices on a network. Each layer in the network stack performs specific tasks and functions and works in collaboration with the other layers to transmit and receive data between endpoints. The network stack, which can be organized according to the OSI (open systems interconnection) model, is a fundamental component of any network communication and plays an important role in ensuring smooth and efficient data transmission. Typical layers in such a network stack can be, for example, a physical layer (layer 1), a data link layer (layer 2), or a network layer (layer 3).

The physical layer handles the physical transmission of data via the network medium. It defines the electrical, mechanical and functional properties of the connection between the devices. The data link layer is responsible for error detection and correction as well as for controlling access to the medium. For example, MAC addresses are used here to identify devices on a local network. The network layer is responsible for forwarding data packets between different networks. It uses IP addresses to determine the path for data packets and to make routing decisions. The network stack enables interoperability of devices and applications on different networks since it ensures that data can be transmitted in a uniform format and according to agreed rules. The use of layers also allows for a clear separation of responsibilities and easier maintenance and extension of network protocols.

Another advantage can be achieved within the scope of the present invention if data packets are captured in the form of a list of data packets, the list comprising at least one indication regarding content of each data packet. This allows for a detailed analysis of the data packets with regard to the causalities between application events and network performance. This furthermore has the advantage that more efficient transmission of information or data regarding the content of the captured and/or extracted data packets can be ensured. In addition, this allows for a significantly more efficient reduction in the computational load and/or processing time for analysis.

It may further be possible for data packets to be captured using an E2 service model for an E2 interface and/or an E2 service model for performance measurement for an E2 interface.

On the one hand, this makes it possible for detailed information about individual data packets to be available not only at the endpoints, but also to be tracked by the network infrastructure itself. This has the advantage that the performance of forwarding data packets within the communications network can be analyzed better and faster. On the other hand, this means that no special measuring equipment needs to be used to collect data regarding network monitoring.

Furthermore, according to an example embodiment of the present invention, initiation of the measure may comprise at least one of the following further steps:
initiating an adaptation of a configuration of a network to avoid degradation of a network service, in particular forwarding of data packets, or a disruption within the network;
initiating an adaptation of an application to avoid degradation of a network service or a disruption within the O-RAN system;
initiating an adaptation of a property of the network and/or of an application on the basis of a predetermined network monitoring task.

This has the advantage that, based on the results of the analyzed data packets and/or on the basis of the particular network monitoring task, the behavior of the network or of the applications on each of the endpoints can be adapted in order to increase network performance or to detect errors at an early stage. Furthermore, it allows for network monitoring to be adapted accordingly so that it will be significantly more effective and/or efficient.

Advantageously, within the scope of the present invention, at least part of the method may be assigned, as a sub-function of a monitoring function, to an xApplication, i.e., xApp, and/or an rApplication, i.e., rApp. This makes it possible to ensure more efficient monitoring of the data packets. Furthermore, this has the advantage that the method according to the present invention can become an integral part of the communications network, wherein an integral part can be understood as a function that is permanently or firmly implemented in a communications system. It is further possible that an implementation of the method according to the present invention as an xApp/rApp advantageously enables the function to be installed and/or executed on any O-RAN system.

Another advantage can be achieved within the scope of the present invention if an orchestration function calculates a division of the method into at least two sub-functions depending on a temporal and/or a resource-related condition. This enables significantly more powerful and detailed network monitoring to be provided, taking into account time constraints and/or available network resources.

The present invention also relates to a network function for network monitoring in an O-RAN system, which is configured to carry out the method according to the present invention. The network function according to the present invention thus entails the same advantages as have been described in detail with reference to a method according to the present invention.

The present invention also relates to a computer program comprising commands which, when the computer program is carried out by a network function, cause the latter to carry out the method according to the present invention. The computer program according to the present invention thus entails the same advantages as have been described in detail with reference to the method according to the present invention.

The present invention also relates to a computer-readable storage medium comprising commands which, when carried out by a network function, cause the latter to carry out the steps of the method according to the present invention. The computer-readable storage medium according to the present invention thus entails the same advantages as have been described in detail with reference to the method according to the present invention.

Furthermore, the method according to the present invention can also be carried out as a computer-implemented method.

Further advantages, features and details of the present invention can be found in the following description, in which exemplary embodiments of the present invention are described in detail with reference to the figures. The features mentioned and/or shown herein can be essential to the present invention, individually or in any combination.

### BRIEF DESCRIPTION OF THE DRAWINGS

FIG. 1 shows a schematic visualization of a method, a device, a storage medium and a computer program according to exemplary embodiments of the present invention.

FIG. 2 shows a schematic representation from the related art.

FIG. 3 shows a schematic representation according to exemplary embodiments of the present invention.

FIG. 4 shows another schematic representation according to exemplary embodiments of the present invention.

FIG. 5 shows another representation according to exemplary embodiments of the present invention.

FIG. 6 shows yet another schematic representation according to exemplary embodiments of the present invention.

### DETAILED DESCRIPTION OF EXAMPLE EMBODIMENTS

In the following figures, identical reference signs are also used for the same technical features of different embodiments.

The present invention describes a new process flow that allows for improved online monitoring of the network and/or detection of performance degradations even at the lower layers of a communications stack or protocol stack. This allows relevant changes to be detected before an actual application failure occurs. Based on a prediction of potential failures, appropriate countermeasures can be taken, such as replacing defective components during the next maintenance window or reconfiguring the network to adjust end-to-end performance. Such countermeasures may therefore relate to adaptations of the network or application when monitoring and predictive information is made available in an appropriate manner, or of both the network and the application in a more complex scenario. The present invention moreover allows for the better tracking of application errors to a cause in the network during post-processing of the monitoring data. This reduces downtimes and improves the overall efficiency of the application.

Based on the interfaces and services provided by O-RAN technology in mobile communications systems, the methods according to the present invention can provide significantly more powerful and detailed network monitoring. The present invention can use the O-RAN service models E2SM-NI and E2SM-KPM to capture packets and relevant performance measurements directly at the network interfaces.

This means that detailed information about individual packets can not only be available at the endpoints, but can also be tracked by the network infrastructure itself. Furthermore, network monitoring according to the present invention does not follow a black channel approach in which only the end-to-end performance can be considered, but the method according to the present invention allows for the performance of the forwarding of packets through the network to be analyzed. Advantageously, the use of costly special measuring devices to collect data or, for example, to debug the system after an error has already occurred can be moreover avoided.

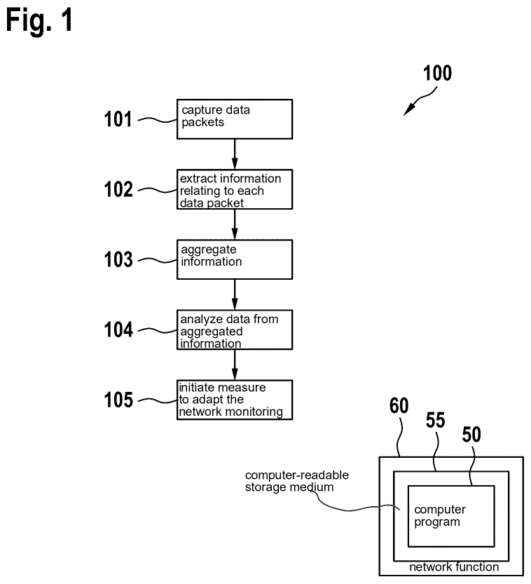

FIG. 1 schematically shows a method 100, a network function 60, a storage medium 55, and a computer program 50 according to exemplary embodiments of the present invention. FIG. 1 illustrates, according to exemplary embodiments of the present invention, a method for packet-based network monitoring in an O-RAN system in order to initiate a measure for adapting network monitoring, comprising the following steps:

In step 101, data packets are captured at an interface of the O-RAN system using an O-RAN service model. According to step 102, information relating to each data packet is extracted on the basis of a selection criterion for network monitoring, wherein the selection criterion is specific to a particular network monitoring task. In step 103, the information relating to each data packet is aggregated in order to analyze the data contained in the information. In step 104, the data from the aggregated information are then analyzed on the basis of a predetermined analysis model. The analysis model comprises an algorithm for evaluating the data. In step 105, a measure is initiated to adapt network monitoring on the basis of the result of the analysis.

FIG. 1 furthermore shows a network function 60 which comprises a computer-readable storage medium 55. The storage medium 55 comprises a computer program 50.

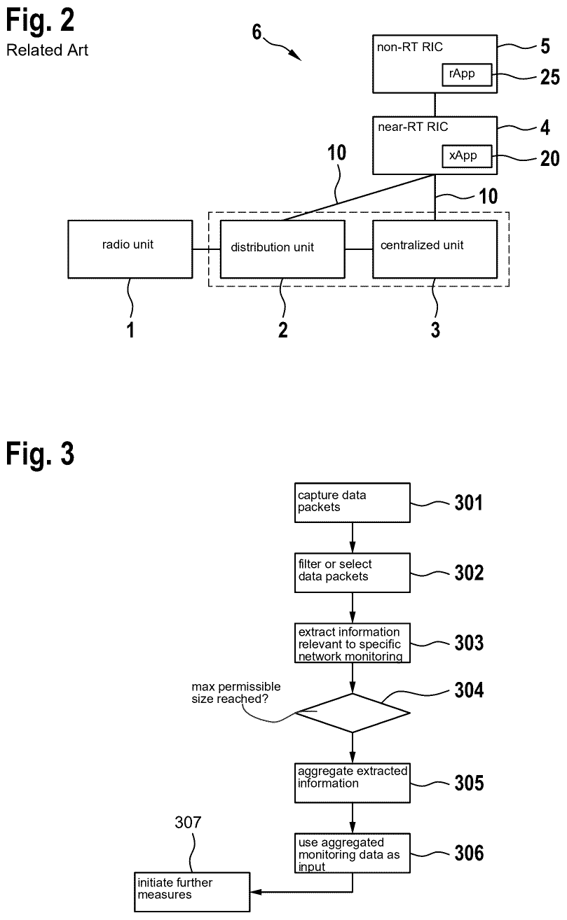

FIG. 2 shows, by way of example, various components of a conventional O-RAN system 6 from the related art. The O-RAN system 6 comprises an intelligent RAN controller for near-RT applications 4 (near-RT RIC), which enables control and optimization of O-RAN nodes or E2 nodes 1, 2, 3 (e.g., CU, DU, eNB, gNB) and resources in near-RT. FIG. 2 further shows a non-RT intelligent RAN controller 5 (non-RT RIC), which has the task of supporting intelligent RAN optimization by providing policy-based guidance, ML model management, and enrichment information for the near-RT RIC function. FIG. 2 moreover shows a so-called xApp 20 and an rApp 25. xApp 20 and rApp 25 are each applications hosted on the near-RT RIC 4 and non-RT RIC 5, respectively, where they can provide value-added services. xApp 20 stands for xApplication and refers to applications that run in the Open RAN architecture. These applications can perform various functions within RAN operation, such as optimizing the network, controlling resources or improving the user experience. rApp 25 stands for rApplication and specifically refers to applications that are executed in non-RT RIC 5 and interact with the radio access network components in an Open RAN environment 6. These applications can help improve the performance and efficiency of radio communication.

Radio unit 1 (RU) is the hardware component responsible for signal transmission. It contains transmitter and receiver antennas as well as the distributed units for signal processing. Distributed unit 2 (DU) is a component that is placed near radio unit 1. Said component 2 performs signal processing tasks to minimize latency and optimize performance. Centralized unit 3 (CU) is another component of the Open RAN system and can include various central control and management functions. Centralized unit 3 coordinates and controls all RU and DU units 1, 2 in the network.

FIG. 2 further shows an E2 interface 10. The E2 interface 10 is an interface between the E2 nodes 1, 2, 3, such as DU 2, CU 3 and the near-RT RIC 4. The E2 interface 10 enables messaging, such as the exchange of control messages and measurements, or the definition of policies, which are a set of rules used to manage and control the state of managed objects in RAN on the E2 nodes 2, 3 between these components. There are also interface-related application protocols with a set of defined procedures to standardize the communication messages between the E2 nodes 2, 3 and the near-RT RIC 4. In addition, there are so-called service models (E2SMs), which define the content of the communication messages via the E2 interface 10. For example, there are the following E2SMs:
E2SM-NI: This is a service model that can be exposed via the E2 interface 10. The E2SM-NI provides, for example, a network interface and allows the modification of incoming and outgoing network interface message contents. The E2 nodes 1, 2, 3 can use these REPORT type E2 indication messages to send messages.
E2SM-KPM: Another service model that can be provided via the E2 interface 10. It can forward the available performance metrics from E2 nodes to the xApp(s) on the near-RT RIC 4. The E2 nodes 1, 2, 3 can use these REPORT type E2 indication messages to send messages.

The E2 nodes 1, 2, 3 may include RAN functions supporting one or more RIC services, i.e., services provided on an E2 node 1, 2, 3 to enable access to messages and measurements and to enable control of the E2 node 1, 2, 3 from the near-RT RIC 4. The following RIC service, called REPORT, can be used for example. The REPORT is a RIC service provided by an E2 node 1, 2, 3 that can be used by the near-RT RIC 4. According to a subscription model, an E2 node 2, 3 can send a message to the RIC 4 on the basis of an event trigger.

FIG. 3 shows a schematic representation according to exemplary embodiments of the present invention. FIG. 3 shows, by way of example, possible steps of an exemplary embodiment of the method according to the present invention. In particular, FIG. 3 shows how network monitoring could be implemented depending on the actual data to be processed and the task to be accomplished.

In step 301, data packets transmitted in a network are captured by an interface 10 and made available to the control and management level.

Optionally, it is possible for the captured data packets to be recorded, for example, as a list of data packets, wherein the list includes information and/or details, e.g., about the source and destination of the data packets, the network protocol used, the arrival time, or the payload.

According to step 302, the captured data packets are filtered or selected because not all data packets captured by the monitoring interface 10 are relevant to a particular monitoring task. In such a case, data packets that should not be taken into account can be discarded or not selected so that they do not need to be processed further.

In step 303, information relevant to the specified network monitoring is extracted from the captured data packets. In the case of capturing data packets in the form of the above-mentioned list, processing all these details can increase the computational load of the monitoring function, so that only information relevant to the particular monitoring task should be extracted from the list. This in turn depends on how the monitoring function is to be used. For example, for time analysis, the arrival time is of great importance, while the payload may not be needed.

In step 305, the extracted data may be aggregated so that not every packet results in a single sample. Instead, information or data from multiple data packets can be aggregated to derive a statistical representation or distribution. For example, minimum, average and/or maximum values can be derived and/or an aggregated sample can be considered per time interval. The statistical representation can be, for example, a probability density function (pdf) and/or any variable (e.g., percentile) derived from the function. This function (pdf) can also change over time (time variant), which can be taken into account in a possible optimization of the system. To track the development over time, the monitoring function must timestamp the samples. In one implementation, these timestamps can be synchronized with other network components to correlate them with events in the components.

In step 306, the aggregated monitoring data are used as input for processing and analysis functions appropriate for the particular monitoring task. The selection of possible evaluation models or algorithms for analyzing the data can be diverse. In addition to simple analysis and/or evaluation models to determine whether the network's forwarding capabilities are within an expected range, there may also be more complex algorithms for statistical analyses, for detecting change points and/or for classification.

In step 307, further measures can be initiated on the basis of the results of step 306. For example, adjustments to the network or application can be made to avoid, for example, a drop in the performance of a network service, in particular forwarding of data packets, or to optimize the performance of the network. In step 308 it is shown that the process flow according to this exemplary embodiment of the method according to the present invention can be repeated. The various steps of the above-described exemplary embodiment of the method according to the present invention may be subject to individual time constraints and computational effort. This can depend heavily on the rate of incoming packets, the complexity of the algorithms, the size of the data sets to be processed, and the time required to respond to a network event. For example, a very high arrival rate of packets combined with limited computing resources for executing the monitoring function can lead to buffer overflows if the processing of captured packets is slower than the arrival of new packets. For this purpose, according to step 304, a query is carried out regarding the buffer or size of the batch, i.e., the specified size of the task package. If the maximum permissible size were reached, this means according to step 304 that a maximum number of extracted data or information from the captured data packets has been reached and that further processing according to step 305 takes place. If there were still capacity available for further data, a decision would be made in step 304 that further data packets can be captured and that data relating to the particular network monitoring task can be extracted until the maximum is reached. Similarly, if the monitoring function is used to predict potential application errors on the basis of the network behavior observed (e.g., by detecting a trend toward a continuously decreasing data rate), the entire analysis must be completed in such a way that there is sufficient time for countermeasures to be taken before the application fails.

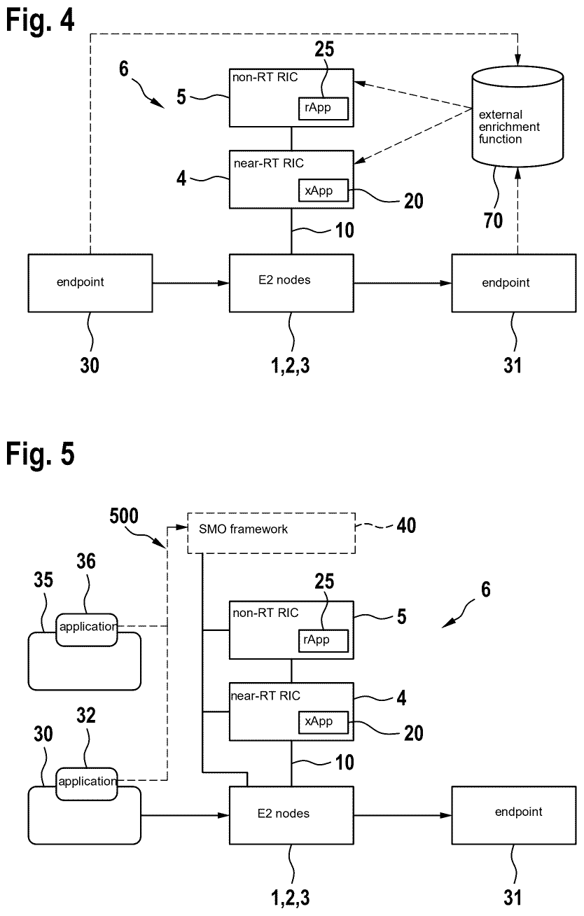

FIG. 4 shows a schematic representation according to exemplary embodiments of the present invention. FIG. 4 shows an exemplary system representation of the present invention with respect to an example application case with two endpoints 30, 31 exchanging data in a communications network. The exchanged data can be enriched by means of an external enrichment function 70. FIG. 4 further shows an O-RAN system 6 which, by way of example, comprises the E2 nodes 1, 2, 3, a near-RT-RIC 4 and a non-RT-RIC 5.

In this exemplary embodiment according to FIG. 4, taking into account the respective technical capabilities of the near-RT RIC 4 and the non-RT RIC 5, certain sub-functions for network monitoring, as described with reference to FIG. 1 or 3, can be used as a network function in an xApp 20 and/or in an rApp 25 or can be arranged accordingly in the RIC 4 and/or in the RIC 5 on the basis of calculations and/or specifications. These sub-functions can, for example, be provided as virtualized functional units, such as part of a monitoring function, which can be dynamically assigned to the near-RT RIC 4 or the non-RT RIC 5. With such an assignment, an orchestration function (not shown) can optionally be used, which can, for example, check the time constraints and computational effort. The orchestrator, which can be provided as a guideline (software-based) or as part of the xApp 20 or rApp 25 itself, calculates a suitable division and/or implementation of the sub-functions depending on the network monitoring requirements and assigns them accordingly to the two RIC components 4, 5.

FIG. 5 shows another schematic system representation according to exemplary embodiments of the present invention. In this exemplary embodiment according to FIG. 5, a closer interaction between a user application 32, 36, and xApp 20 and/or rApp 25 via direct and/or non-direct communication is shown in order to enable more efficient monitoring of the transmitted data packets. The following models or concepts are optionally possible:
1) The application 32, 36 fully instructs and configures 500 the xApp/rApp monitoring processes, or each application 32, 36 has its own monitoring xApp/rApp, or
2) the xApp/rApp monitoring function(s) can learn the monitoring configuration entirely on the basis of established machine learning or artificial intelligence methods. For example, a monitoring function can observe the data traffic characteristics or identify certain data traffic markers and configure 500 them accordingly, or
3) any combination of 1) and 2), where the configuration 500 is performed partly by the application 32, 36 and partly by the self-learning capabilities of the monitoring functions.

The monitoring xApp 20/rApp 25 within the O-Ran system 6 can be configured 500 with respect to various aspects, including aspects such as
what type of packets should be monitored,
how often monitoring should be carried out (e.g., every packet or only every 100th packet),
which part of the statistics should be evaluated (e.g., entire pdf, percentile or median),
which application flow should be monitored,
configuration of triggers for detailed network monitoring in case of certain application events or conditions.

The (auto) configuration of the monitoring function should further take into account the time constraints, the computational effort and the available resources.

FIG. 5 further shows that an application 32, 36 served via the network can interact directly with the SMO (service management and orchestration) framework 40 of the communications network in order to configure 500 the monitoring process provided by xApp 20/rApp 25. This can be done either by the application 32, 36 itself, which is made available on endpoints on the UE side 30 or on edge servers 35. Regardless of whether the application 32, 36 includes its own xApp 20/rApp 25 that can be uploaded to the RIC 4, 5 or whether the application 32, 36 includes its own configuration for xApps 20/rApps 25 already provided in the RIC 4, 5, the SMO framework 40 governs and controls the provision on the network.

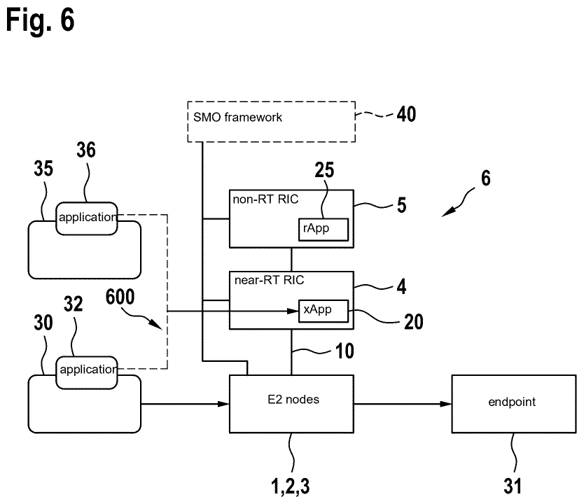

FIG. 6 shows another schematic system representation according to exemplary embodiments of the present invention. In this exemplary embodiment shown in FIG. 6, neither App1 32 nor App2 36 can configure 600 xApp 20 and/or rApp 25 via the SMO framework 40. In this exemplary embodiment, in contrast to the example according to FIG. 5, a direct connection can be used for the configuration 600 of the application 32, 36 to the respective xApp 20 and/or rApp 25, which is provided on endpoints on the UE side 30 or on edge servers 35. Furthermore, the processing and analysis of information from the aggregated data can be carried out using machine learning-based methods. This may include, for example, learning about causal dependencies and/or optimizing the detection scheme (cf. black-box optimization) and/or learning about relevant packet information. For example, the monitoring function can capture anomalies that were not known at the time the method was designed. Furthermore, the analysis model used to analyze the data can be improved. Alternatively, the selection, extraction and aggregation of data packets according to the present invention in this exemplary embodiment according to FIG. 6 can be optimized, for example, such as to filter out irrelevant packets, extract only relevant information to be computationally efficient, or aggregate data from data packets in a way that makes the most sense for the processing scheme.

The above description of the embodiments describes the present invention exclusively in the context of examples. Of course, individual features of the embodiments, provided they make technical sense, can be freely combined with one another without departing from the scope of the present invention.

1.-11. (canceled)

12. A method for packet-based network monitoring in an O-RAN system in order to initiate a measure for adapting network monitoring, the method comprising the following steps:
capturing data packets at an interface of the O-RAN system using an O-RAN service model;
extracting information relating to each data packet based on a selection criterion for network monitoring, wherein the selection criterion is specific to a particular network monitoring task;
aggregating the extracted information relating to each data packet in order to analyze the data contained in the information;
analyzing the data from the aggregated information based on a predetermined analysis model, wherein the analysis model includes an algorithm for evaluating the data; and
initiating a measure to adapt network monitoring based on a result of the analysis.

13. The method according to claim 12, further comprising the following further step:
selecting a particular data packet from the captured data packets depending on the selection criterion for network monitoring in order to extract the information relating to the particular data packet.

14. The method according to claim 12, wherein the capturing includes the following further step:
capturing the data packets based on at least one piece of network layer information, the network layer information being specific to any protocol layer of a network protocol stack.

15. The method according to claim 12, wherein the data packets are captured in the form of a list of data packets, the list including at least one indication regarding content of each data packet.

16. The method according to claim 12, wherein the data packets are captured using an E2 service model for an E2 interface and/or an E2 service model for performance measurement for an E2 interface.

17. The method according to claim 12, wherein the initiation includes at least one of the following further steps:
initiating an adaptation of a configuration of the network to avoid degradation of a network service, including forwarding of data packets, or a disruption within the network;
initiating an adaptation of an application to avoid degradation of a network service or a disruption within the O-RAN system;
initiating an adaptation of a property of the network and/or of an application based on a predetermined network monitoring task.

18. The method according to claim 12, wherein at least part of the method is assigned, as a sub-function of a monitoring function, to an xApp and/or an rApp.

19. The method according to claim 12, wherein an orchestration function calculates a division of the method into at least two sub-functions depending on a temporal and/or a resource-related condition.

20. A network function for network monitoring in an O-RAN system in order to initiate a measure for adapting network monitoring, the network function being configured to perform the following steps:
capturing data packets at an interface of the O-RAN system using an O-RAN service model;
extracting information relating to each data packet based on a selection criterion for network monitoring, wherein the selection criterion is specific to a particular network monitoring task;
aggregating the extracted information relating to each data packet in order to analyze the data contained in the information;
analyzing the data from the aggregated information based on a predetermined analysis model, wherein the analysis model includes an algorithm for evaluating the data; and
initiating a measure to adapt network monitoring based on a result of the analysis.

21. A non-transitory computer-readable storage medium on which are stored commands for packet-based network monitoring in an O-RAN system in order to initiate a measure for adapting network monitoring, the commands, when executed by a network function, causing the network function to perform the following steps:
capturing data packets at an interface of the O-RAN system using an O-RAN service model;
extracting information relating to each data packet based on a selection criterion for network monitoring, wherein the selection criterion is specific to a particular network monitoring task;
aggregating the extracted information relating to each data packet in order to analyze the data contained in the information;
analyzing the data from the aggregated information based on a predetermined analysis model, wherein the analysis model includes an algorithm for evaluating the data; and
initiating a measure to adapt network monitoring based on a result of the analysis.
